(19) United States
(12) Patent Application Publication
(10) Pub. No.: US 2023/0155361 A1
(43) Pub. Date: May 18, 2023

(54) Electrical Cable with Mounting Webbing

(71) Applicant: Panduit Corp., Tinley Park, IL (US)

(72) Inventor: Rodney G. Rouleau, Manhattan, IL (US)

(73) Assignee: Panduit Corp., Tinley Park, IL (US)

(21) Appl. No.: 17/529,915

(22) Filed: Nov. 18, 2021

(51) Int. Cl. H02G 3/04

(52) U.S. Cl. CPC H02G 3/0406

(57) ABSTRACT

An electrical cable has a webbing separating a first insulated conductor from a second insulated conductor wherein the webbing is configured to accommodate mounting hardware. Alternatively, the webbing may be placed on one or more sides of an electrical cable.

### FIELD OF THE INVENTION

The present invention is generally related to electrical cables and, more specially, to electrical cables with a mounting webbing placed either in between conductors or on one or more sides of the cable.

### BACKGROUND

Common solar panels produce less than 50 volts per panel and less than 25 amps per panel. The solar panels all produce direct current (DC), and every panel must be connected to the power collection circuits. The solar panels are normally held in place with a metal frame structure and the power collection circuit cables are normally attached to the frame with clips, cable ties, or other fastening means. Installers are always looking for a low cost and simple method of attaching the power collection circuit cables to the metal frame structures.

Flexible non-metallic multi-conductor cables have been used for decades. One common type of non-metallic multi-conductor cables has the trade name of Romex and only rated for indoor use (see FIG. 1). Another common type of non-metallic multi-conductor cable is UF-B that is rated for outdoor use and direct burial (see FIG. 2). The Romex and UF cable are normally installed using a staple or clip (see FIG. 3). The staples can only be used with wooden structures. A cable with the flexibility of Romex or UF cable and multiple attachment options would benefit installers.

Currently non-metallic cables are installed using various types of hammer installed staples or manual staple guns with special staples (see FIGS. 4 and 5). Most non-metallic cables are installed with the hammer type staples. The manual staple guns are not common, and they require the proper size and type of staples to function properly. The manual staple guns are hard to operate in confined spaces and can cause fatigue with continuous use.

### SUMMARY

In one embodiment, an electrical cable has a webbing separating a first insulated conductor from a second insulated conductor wherein the webbing is configured to accommodate mounting hardware. In a second embodiment, the webbing may be placed on one or more sides of an electrical cable.

### BRIEF DESCRIPTION OF THE FIGURES

FIG. 1 shows a prior art electrical cable.

FIG. 2 is an isometric view of another prior art electrical cable.

FIG. 3 shows a prior art mounting clip for the electrical cable of FIGS. 1 and 2.

FIG. 4 shows a specialized prior art stable gun.

FIG. 5 shows a prior art specialized stable used for mounting the electrical cable of FIGS. 1 and 2.

FIG. 6 shows a first embodiment of an electrical cable with a mounting webbing.

FIG. 7 shows a second embodiment of an electrical cable with a mounting webbing that is similar to the embodiment of FIG. 1 but with an additional conductor.

FIG. 8 shows a third embodiment of an electrical cable with a mounting webbing that is similar to the embodiment of FIG. 1 but with the holes removed.

FIG. 9 shows a nail gun that can be used with the embodiment of FIG. 8.

FIG. 10 shows the necessity of the nail gun tip fitting in between the conductors of the embodiment of FIG. 8.

FIG. 11 shows a fourth embodiment of an electrical cable with a mounting webbing in which the webbing is placed to the side of the cable instead of between two conductors.

FIG. 12 shows a fifth embodiment of an electrical cable with mounting webbing that is similar to the embodiment of FIG. 11 but with added mounting holes.

FIG. 13 shows a sixth embodiment of an electrical cable with mounting webbing in which the webbing is placed on both sides of the cable.

FIG. 14 shows a seventh embodiment of an electrical cable with mounting webbing that is similar to the one of FIG. 13 but with added mounting holes.

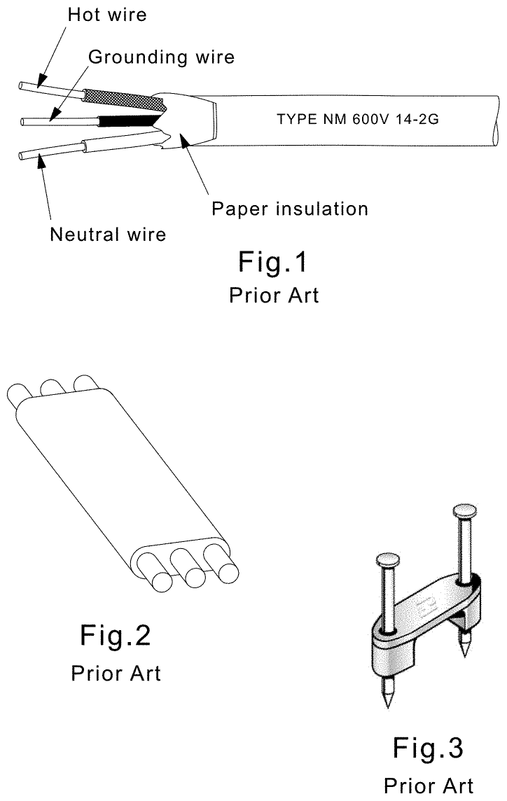

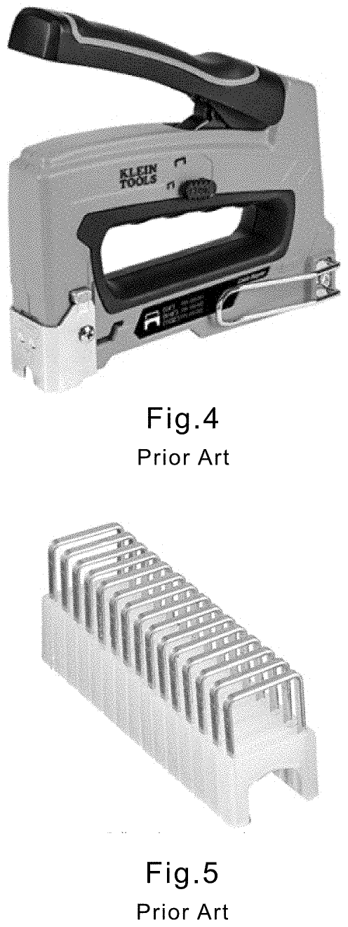

### DETAILED DESCRIPTION OF THE INVENTION

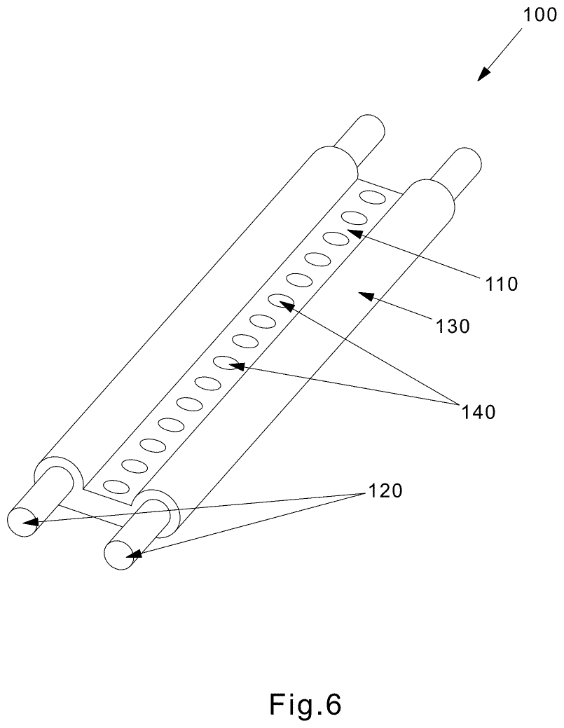

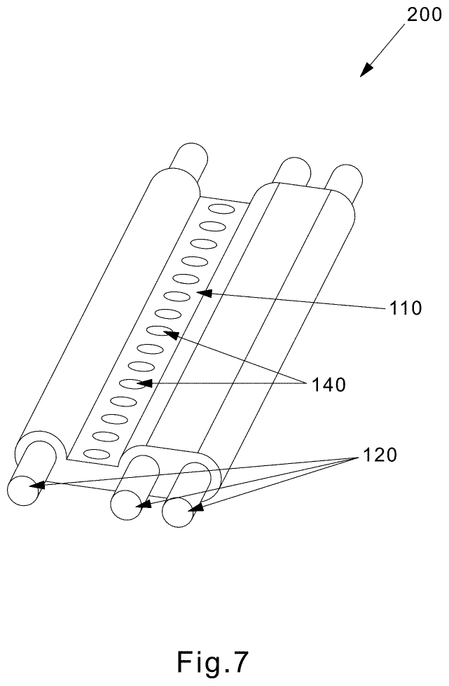

FIG. 6 shows a first embodiment of an electrical cable 100 with a mounting a mounting webbing 110. In this embodiment the webbing 110 is placed between two conductors 120 of the electrical cable. In one embodiment the webbing 110 can be made of the same material as the insulation jacket 130. FIG. 6 shows an embodiment with mounting holes 140 in the webbing which can be attached to a structure by multiple means. Customary staples, screws, push mounts, fir tree mounts, nails, clips, are some of the options.

FIG. 7 shows a second embodiment 200 similar to that of FIG. 6 but with an additional conductor 120.

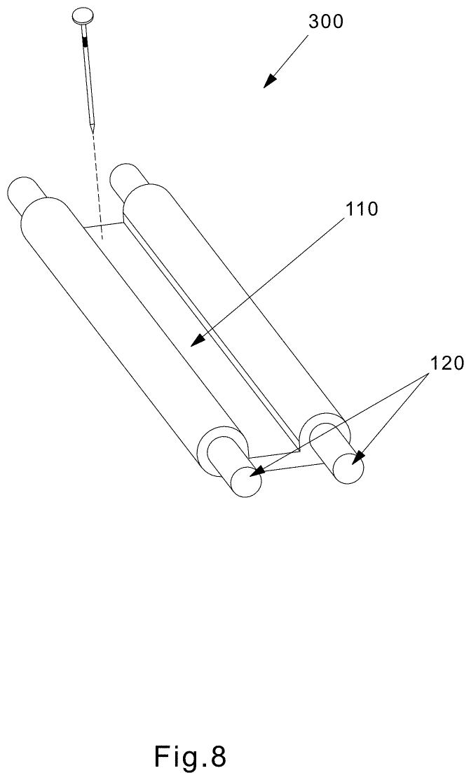

FIG. 8 shows a third embodiment 300 that is similar to the embodiment of FIG. 6 but has the mounting holes in the webbing removed.

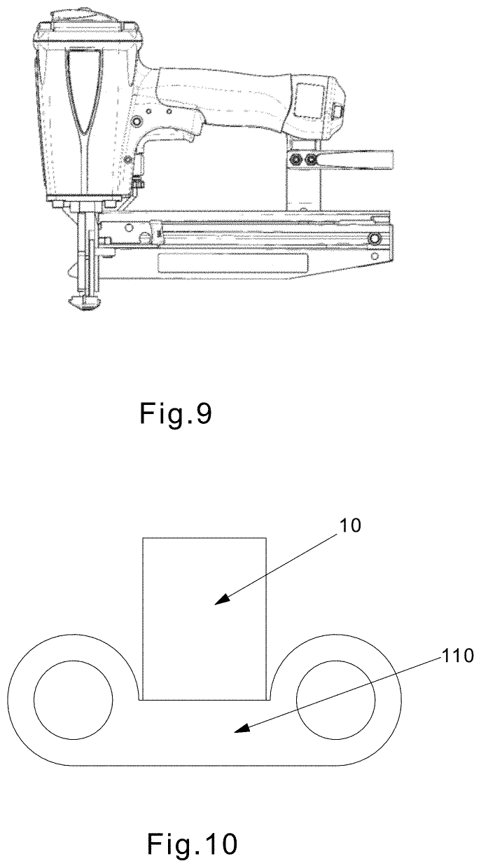

FIG. 9 shows a pneumatic nail gun that can be used to install the electrical cable of FIG. 8. As shown in FIG. 10, the tip of the nail gun should fit in between the conductors 120. In one embodiment, the webbing is recessed in order to help guide the tip of the nail gun.

NEC Article 334.30 covers the requirements for securing and supporting non-metallic cables. Article 334.30 states that the securing and supporting must be designed and installed so as not to damage the cable. Relocation of the mounting web could reduce the possibility of cable damage during installation.

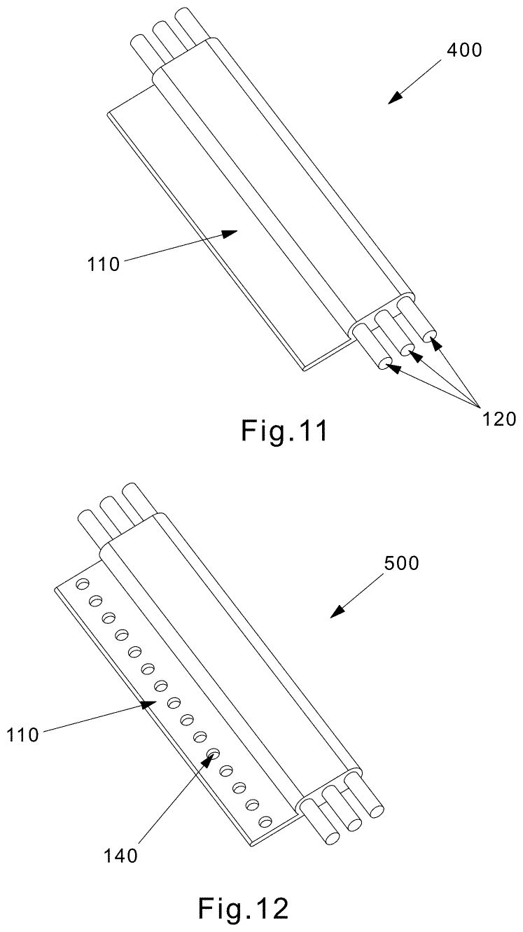

FIG. 11 shows a fourth embodiment 400 in which the webbing 110 is placed on the side of the cable as opposed to in between conductors. A fifth embodiment 500 shown in FIG. 12 is similar to FIG. 11 but with added mounting holes 140.

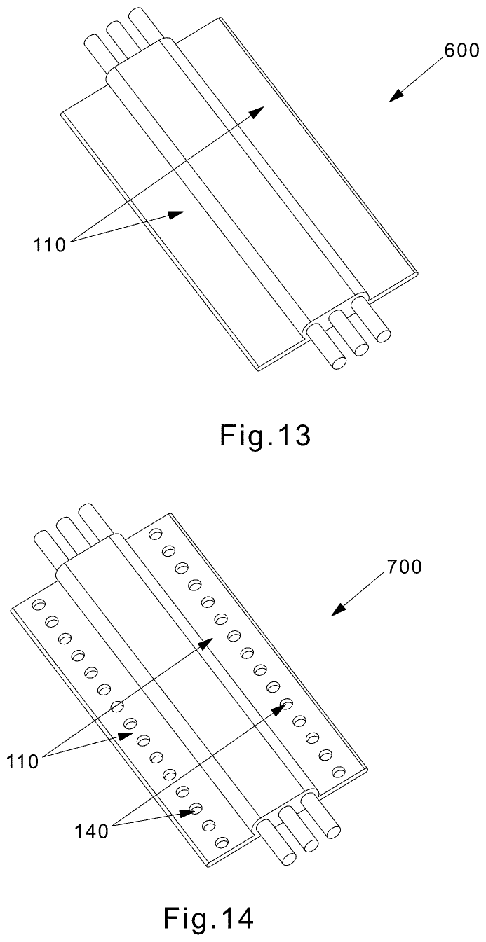

FIG. 13 shows a sixth embodiment 600 in which the webbing 110 is placed on both sides of the electrical cable. A seventh embodiment 700 shown in FIG. 14 is similar to the one of FIG. 13 but with added mounting holes 140.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An electrical cable comprising:
a first insulated conductor;
a second insulated conductor; and
a webbing separating the first insulated conductor from the second insulated conductor wherein the webbing has a width configured to accommodate mounting hardware and further wherein the webbing is offset from a central axis of the first conductor and a central axis of the second conductor such as to allow the webbing and first and second insulated conductors to lay flush when placed upon a flat surface.

2. (canceled)

3. The electrical cable of claim 1 wherein the webbing has holes to further accommodate the mounting hardware.

4. The electrical cable of claim 1 further comprising a third insulated conductor adjacent to the first insulated conductor.

5. The electrical able of claim 1 wherein insulation of the first and second insulated conductor and the webbing are comprised of the same material.

6. An electrical cable comprising:
a first insulated conductor;
a second insulated conductor; and
a first webbing adjacent to at least one of the first and second conductors wherein the webbing has a width configured to accommodate mounting hardware and further wherein the webbing is offset from a central axis of the first conductor and a central axis of the second conductor such as to allow the webbing and first and second insulated conductors to lay flush when placed upon a flat surface.

7. (canceled)

8. The electrical cable of claim 6 wherein the first webbing has holes to further accommodate the mounting hardware.

9. The electrical cable of claim 1 further comprising a second webbing opposite the first webbing.
